(19) United States
(12) Patent Application Publication
(10) Pub. No.: US 2008/0180599 A1
(43) Pub. Date: Jul. 31, 2008

(54) BACKLIGHT UNIT, METHOD FOR MANUFACTURING THE SAME, AND DISPLAY HAVING THE SAME

(75) Inventors: Ju-Hwa HA, Seoul (KR); Byung-Yun JOO, Seoul (KR); Jung-Wook PAEK, Suwon (KR); Jin-Sung CHOI, Cheonan (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/017,170

(22) Filed: Jan. 21, 2008

(30) Foreign Application Priority Data
Jan. 26, 2007 (KR) 10-2007-0008340

(51) Int. Cl. G02F 1/13357; G02B 5/02; B29C 65/14

(52) U.S. Cl. 349/64; 362/355; 430/6

(57) ABSTRACT

The present invention relates to a backlight unit, a manufacturing method thereof, and a display including the backlight unit. According to the present invention, an optical plate, a diffusion sheet, and an optical sheet are integrally formed using adhesives having diffusion beads dispersed therein.

This application claims priority from and the benefit of Korean Patent Application No. 10-2007-0008340, filed on Jan. 26, 2007, which is hereby incorporated by reference for all purposes as if fully set forth herein.

### BACKGROUND OF THE INVENTION

1. Field of the Invention

The present invention relates to a backlight unit, a manufacturing method thereof, and a display having the backlight unit. More particularly, this invention relates to a backlight unit, in which an optical plate, a diffusion sheet, and an optical sheet are integrally formed, a method of manufacturing the backlight unit, and a display including the backlight unit.

2. Discussion of the Background

In general, a liquid crystal display (“LCD”) has various advantageous features such as a lightweight structure, a slim shape, low power consumption, full-color implementation, high resolution, and the like. As such, the fields in which LCDs are applied have been increasingly widened. Presently, LCDs are employed in computers, notebooks, PDAs, telephones, TV sets, audio/video devices, and the like. The light transmittivity of an LCD is controlled, depending upon image signals applied to a plurality of control switches arranged in a matrix pattern, to display a desired image on an LCD panel.

The LCD is not a self light-emitting device and thus, needs a light source such as a backlight. A backlight of an LCD is classified as edge type or direct type depending on the position of the light source.

The edge-type backlight has a light source installed at an edge of an LCD panel, so that the LCD panel is irradiated with light emitted from the light source through a transparent light guide plate disposed under the LCD panel. This edge-type backlight provides good light uniformity and has a long life span, and also, is advantageous in making a thinner LCD. Thus, the edge-type backlight is commonly used to emit light to a small or medium LCD panel. On the other hand, the direct-type backlight has a plurality of light sources under an LCD panel to directly irradiate an entire surface of the LCD panel with light. The direct-type backlight is commonly used for a medium or large LCD panel since it may ensure high brightness.

The direct-type backlight unit includes a lamp to emit light, and a diffusion plate and a plurality of optical sheets are provided over the lamp in order. Here, the optical sheets include a diffusion sheet, a prism sheet, and so on, each of which have a thin film configuration, and these sheets are additionally laminated over the diffusion plate.

Since a thin film diffusion sheet is laminated over the diffusion plate in an additional process, the assembling process thereof is complicated. In addition, since there is an air layer between the diffusion plate and the diffusion sheet, light energy may be transferred when light passes through the air layer, thereby causing light loss. Also, a variety of sheets are used for a large display, which may result in difficult handling and increased costs.

### SUMMARY OF THE INVENTION

The present invention provides a backlight unit, in which a diffusion plate and a diffusion sheet are integrally formed using an adhesive layer with diffusion beads dispersed therein, a method for manufacturing the backlight unit, and a display having the same.

The present invention also provides a backlight unit, in which a diffusion plate, a diffusion sheet, and a variety of optical sheets using an adhesive layer with diffusion beads dispersed therein, a method for manufacturing the backlight unit, and a display having the same.

Additional features of the invention will be set forth in the description which follows, and in part will be apparent from the description, or may be learned by practice of the invention.

The present invention discloses a backlight unit, including an optical plate, an adhesive layer disposed on the optical plate, and a light control sheet adhered to and formed integrally with the optical plate by the adhesive layer. The adhesive layer has diffusion beads dispersed therein and the light control sheet has a plurality of holes formed therein.

The present invention also discloses a method for manufacturing a backlight unit including forming a light control sheet on an optical plate, the light control sheet having a plurality of holes formed therein, disposing an adhesive with diffusion beads dispersed therein between the optical plate and the light control sheet through the holes, and curing the adhesive through UV irradiation to integrally form the optical plate and the light control sheet.

The present invention also discloses a display, including a light source to provide light, a backlight unit, and a panel. The backlight unit includes a light control member to control the light provided from the light source. An optical plate is integrally formed with a light control sheet using an adhesive layer with diffusion beads dispersed therein and the light control sheet has a plurality of holes formed therein. The panel displays an image using light supplied from the backlight unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a backlight unit according to a first exemplary embodiment of the present invention.

FIG. 2 is a sectional view of the backlight unit according to the first exemplary embodiment of the present invention.

FIG. 3 is an enlarged sectional view of a light control member according to the first exemplary embodiment of the present invention.

FIG. 4A and FIG. 4B are a plane view and a perspective view of a diffusion sheet used in the light control member according to the first exemplary embodiment of the present invention.

FIG. 5 is an enlarged sectional view of a light control member according to a second exemplary embodiment of the present invention.

FIG. 6A, FIG. 6B, FIG. 6C, FIG. 6D, and FIG. 6E are sectional views subsequently showing a method for manufacturing the light control member according to a second exemplary embodiment of the present invention.

FIG. 7A and FIG. 7B are views showing a UV photopolymerization mechanism according to an exemplary embodiment of the present invention.

FIG. 8 is an enlarged sectional view of a light control member according to a third exemplary embodiment of the present invention.

FIG. 9 is an enlarged sectional view of a light control member according to a fourth exemplary embodiment of the present invention.

FIG. 10 is an enlarged sectional view of a light control member according to a fifth exemplary embodiment of the present invention.

FIG. 11 is an enlarged sectional view of a light control member according to a sixth exemplary embodiment of the present invention.

FIG. 12A and FIG. 12B are a plan view and a perspective view of a diffusion sheet used in the light control member according to the sixth exemplary embodiment of the present invention.

FIG. 13 is an enlarged sectional view of a light control member according to the seventh exemplary embodiment of the present invention.

FIG. 14A, FIG. 14B, FIG. 14C, FIG. 14D, and FIG. 14E are sectional views subsequently showing a method for manufacturing the light control member according to the second exemplary embodiment of the present invention.

FIG. 15 is an enlarged sectional view of a light control member according to the third exemplary embodiment of the present invention.

FIG. 16 is an enlarged sectional view of a light control member according to the fourth exemplary embodiment of the present invention.

FIG. 17 is an enlarged sectional view of a light control member according to the fifth exemplary embodiment of the present invention.

FIG. 18 is an exploded perspective view of a liquid crystal display provided with the backlight unit according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layer may be present. In contrast, when an element is referred to as being “directly on” or “directly connected to” another element or layer, there are no intervening elements or layers present.

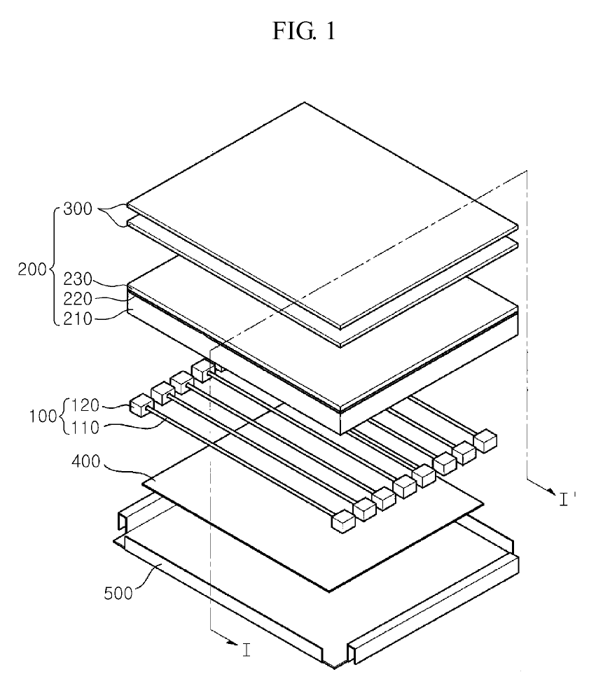

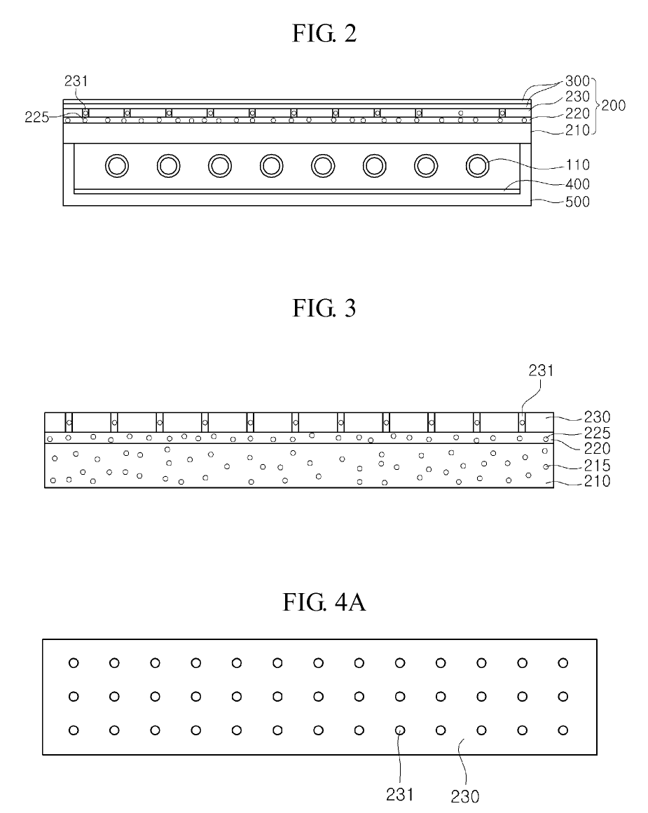

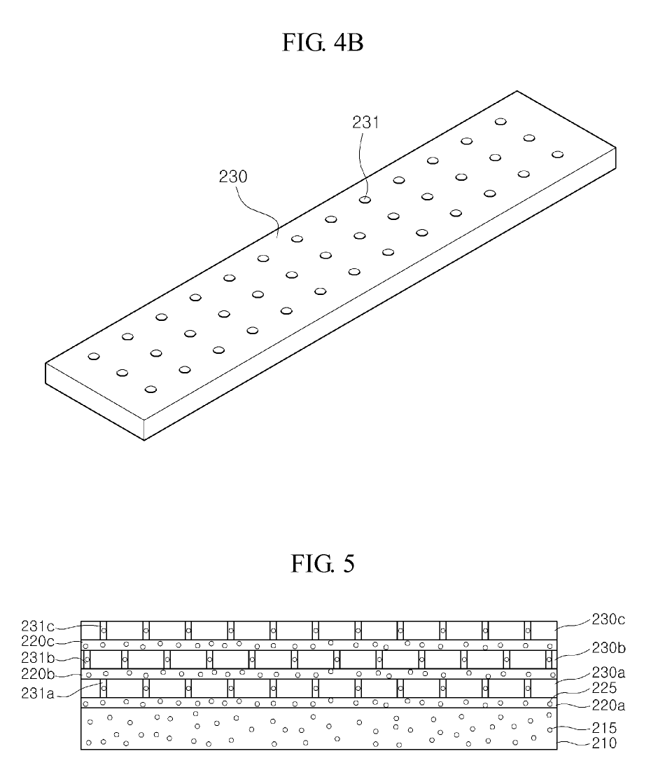

FIG. 1 is an exploded perspective view of a backlight unit according to an exemplary embodiment of the present invention, FIG. 2 is a sectional view taken along line I-I′ of FIG. 1, and FIG. 3 is an enlarged sectional view of a light diffusion member according to this exemplary embodiment of the present invention. In addition, FIG. 4A and FIG. 4B are a plan view and a perspective view of a diffusion sheet employed in the light diffusion member according to this exemplary embodiment of the present invention.

Referring to FIG. 1, FIG. 2, and FIG. 3, the backlight unit according to this exemplary embodiment of the present invention includes a lamp unit 100, a light control member 200, a reflective plate 400, and a receiving container 500.

The lamp unit 100 includes a plurality of lamps 110 arranged in parallel to emit light and lamp holders 120 to fix both ends of the plurality of lamps 110. The plurality of lamps 110 include Cold Cathode Fluorescent Lamps (CCFLs) in the shape of rods. Each lamp 110 includes a glass tube, inert gas contained in the glass tube, and positive and negative electrodes installed at both ends of the glass tube. Phosphor is applied to the inner surface of the glass tube. The lamps 110 may be arranged at equal intervals to provide uniform brightness and the number of lamps 110 may be selected depending on the desired brightness. The lamp holders 120 are installed to cover the positive and negative electrodes of the plurality of lamps 110.

The light control member 200 includes a diffusion plate 210, a diffusion sheet 230, and an adhesive layer 220 to integrally form the diffusion plate 210 and the diffusion sheet 230. In addition, the light control member 200 further includes optical sheets 300 disposed over the diffusion sheet 230 or integrally formed on the diffusion sheet 230.

The diffusion plate 210 is installed over the lamp unit 100 to diffuse light supplied from the lamp unit 100. The diffusion plate 210 is made of acrylic material or a thermoplastic resin such as polymethylmethacrylate (PMMA). In addition, the diffusion plate 210 may have a plurality of diffusion beads 215 with a diameter of 1 to 15 μm dispersed therein as light diffusion particles.

The diffusion sheet 230 is integrally formed on the diffusion plate 210 through the adhesive layer 220 and scatters light provided through the diffusion plate 210, which diffuses the light. The diffusion sheet 230 has a plurality of holes 231 vertically bored therethrough as shown in FIG. 4A and FIG. 4B. The plurality of holes 231 are formed to have a diameter of about 1 to 500 μm and may be arranged regularly or irregularly. Also, the diffusion sheet 230 is made of polycarbonate (PC), polyethylene-based (PE-based) material such as PET (polyethyleneterephthalate), or the like.

The adhesive layer 220 causes the diffusion plate 210 and the diffusion sheet 230 to adhere to each other and to be integrally formed, and a plurality of diffusion beads 225 are dispersed therein as light diffusion particles. Here, the diffusion beads 225 dispersed in the adhesive layer 220 have a diameter of about 1 to 15 μm. In addition, the diffusion beads 225 are made of a material capable of diffusing light, such as acryl or silicon, and may be formed in a circular, oval, or polygonal shape. Also, the diffusion beads 225 may be dispersed in the adhesive layer 220 at a ratio of about 1 to 5 wt %.

Meanwhile, the diffusion beads 215 in the diffusion plate 210 and the diffusion beads 225 in the adhesive layer 220 may be formed to have either the same size or different sizes. Also, the diffusion sheet 230 integrally formed on the diffusion plate 210 by the adhesive layer 220 may have a multi-layered structure, in which the layers laminated in the diffusion sheet 230 are adhered to each other by one or more adhesive layers to be integrally formed.

The optical sheets 300 are arranged over the diffusion sheet 230 to improve optical characteristics of the light supplied from the diffusion plate 210 and the diffusion sheet 230. At this time, the optical sheets 300 may include a micro-lens array, a prism sheet, and a brightness-enhancing sheet. A brightness enhancement film (BEF), and/or a dual brightness enhancement film (DBEF) may be used as a brightness enhancing sheet. Also, the optical sheets 300 may be integrally formed on the diffusion sheet 230 using an adhesive layer. That is, a micro-lens array, a prism sheet, or a brightness-enhancing sheet may be attached to the diffusion sheet 230, which is integrally formed with the diffusion plate 210 by the adhesive layer 220, using another adhesive layer.

The reflective plate 400 is formed under the lamp unit 100 and reflects light leaking from the lamp unit 100 toward the diffusion plate 200.

In addition, the receiving container 500 is formed under the reflective plate 400 and consists of a bottom and sides extending from ends of the bottom to define a receiving space. The optical sheets 300, the diffusion plate 210, and the diffusion sheet 230 are formed integrally with each other, and the lamp unit 100 and the reflective plate 400 are accommodated in the receiving space.

Since the diffusion plate 210 and the diffusion sheet 230 having the plurality of holes 231 formed therein are integrally formed with the adhesive layer 220, it may be possible to enhance the efficiency of a manufacturing process and reduce the manufacturing cost of a display as compared with a case where the diffusion sheet 230 is arranged on the diffusion plate 210 through an additional process. In addition, since the diffusion plate 210 and the diffusion sheet 230 having the holes 231 are integrally formed using the adhesive layer 220 with the diffusion beads 225 dispersed, an air layer between the diffusion plate 210 and the diffusion sheet 230 may be eliminated to decrease the refractive index difference between the diffusion plate 210 and the diffusion sheet 230, thereby improving brightness of the display.

In addition, according to a second exemplary embodiment of the present invention, in which the diffusion plate 210 and the diffusion sheets 230 having the holes 231 are integrally formed using the adhesive layer 220 with the diffusion beads 225 dispersed, it may be possible for a plurality of diffusion sheets 230 to be integrally formed using adhesive layers 220. According to a third exemplary embodiment, it may also be possible for a diffusion sheet 230 and various optical sheets 300 to be integrally formed using adhesive layers 220. Hereinafter, these exemplary embodiments of the present invention will be explained with reference to the accompanying drawings.

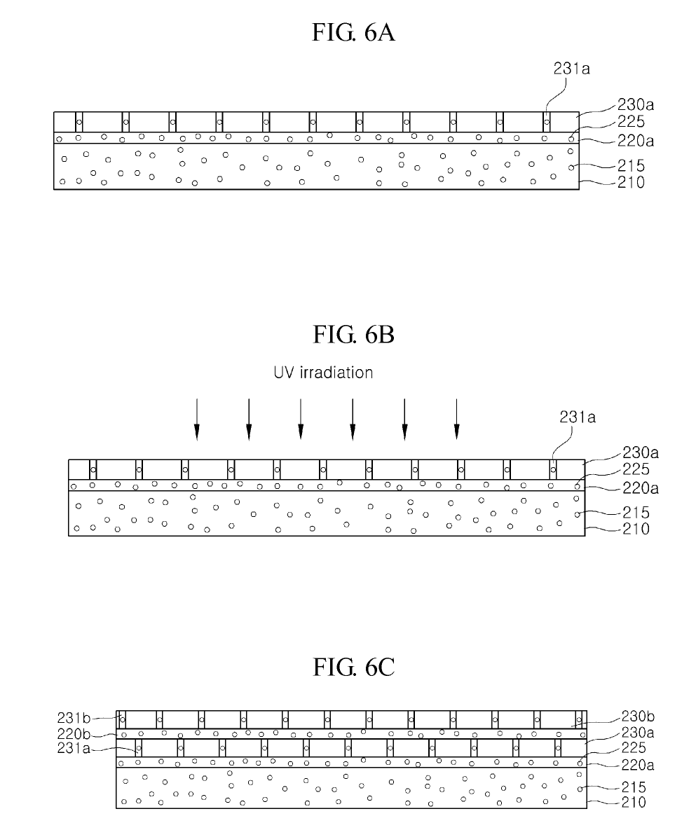

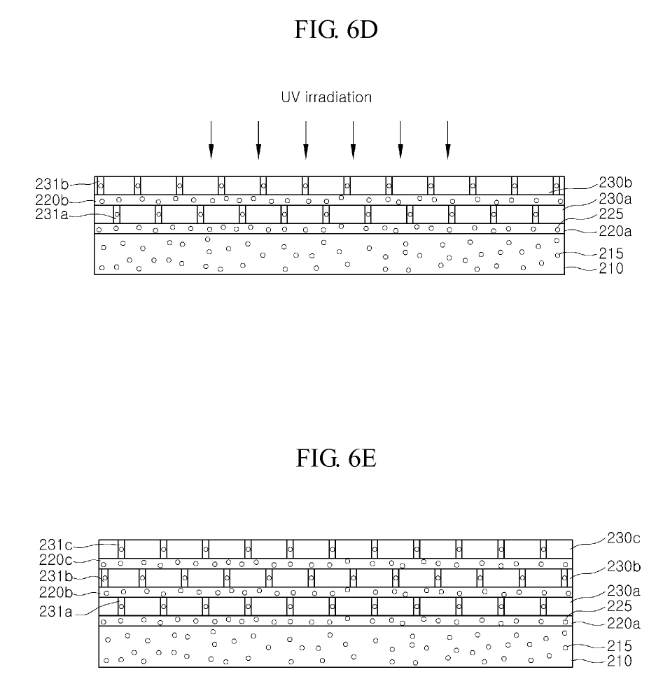

FIG. 5 is an enlarged sectional view of a light control member according to a second exemplary embodiment of the present invention in which a diffusion plate and three diffusion sheets are integrally formed using adhesive layers, and FIG. 6A, FIG. 6B, FIG. 6C, FIG. 6D, and FIG. 6E are sectional views showing a method for manufacturing the light control member according to the second exemplary embodiment of the present invention.

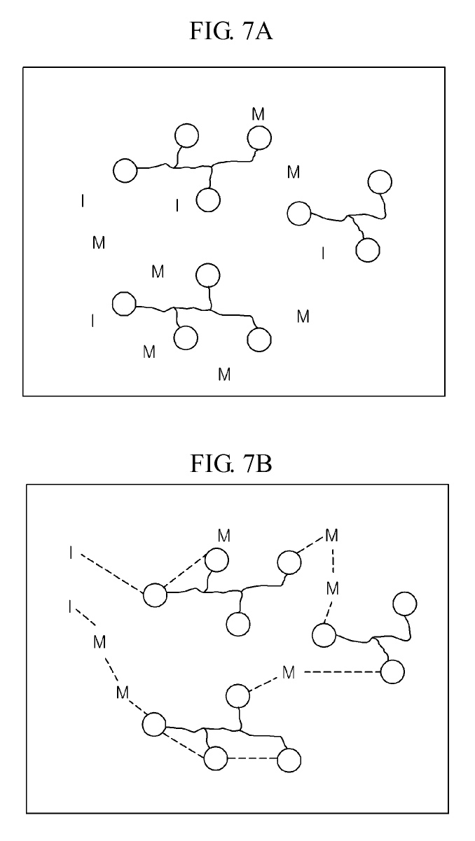

As shown in FIG. 6A, a first diffusion sheet 230a having a plurality of holes 231a formed therein is arranged on a diffusion plate 210 to be in contact therewith. Here, a plurality of diffusion beads 215 are dispersed in the first diffusion plate 210 and the holes 231a formed in the first diffusion sheet 230a are more concentrated at edge areas thereof. In addition, an adhesive with diffusion beads 225 dispersed therein is dropped on the first diffusion sheet 230a. Thereafter, the surface of the first diffusion sheet 230a is scrubbed with a squeegee, roller, or the like, so that the adhesive is spread evenly. Accordingly, the adhesive penetrates downward through the holes 231a of the first diffusion sheet 230a and a first adhesive layer 220a is formed between the diffusion plate 210 and the first diffusion sheet 230a. At this time, the holes 231a of the first diffusion sheet 230a may be filled with the adhesive, or the adhesive may pass completely through the first diffusion sheet 230a, so that the holes 231a are not filled with adhesive. The first adhesive layer 220a includes a photo-crosslinking polymer solution composed of photopolymerization initiator, photopolymerizing monomer, or oligomer, and has a UV adhesive curing mechanism as shown in FIG. 7A and FIG. 7B. In addition, a light stabilizer is additionally mixed with the first adhesive layer 220a, so that the first adhesive layer 220a may be entirely cured during the following UV irradiation. Here, the weight ratio of photopolymerizing monomer to photopolymerization initiator is 900:1 to 4:1. In a case where the weight ratio is 4:1, since the content of the photopolymerization initiator is relatively high the UV irradiation may be performed for several seconds. Meanwhile, in a case where the weight ratio of 900:1, since the content of the photopolymerization initiator is relatively low, the UV irradiation may be performed for several tens of minutes. Of course, in order to shorten the curing time, it may be possible to increase the power of lamps emitting UV light, instead of increasing the content of photopolymerization initiator. The photopolymerization initiator may be selected from acetophenone, benzophenone, and thioxanthone, and the photopolymerizing monomer or oligomer may be selected from acrylate, epoxy acrylate, polyester acrylate, and urethane acrylate. In addition, the diffusion beads 225 included in the first adhesive layer 220a may be made of a material capable of diffusing light, such as acryl or silicon, and may be formed in a circular, oval, or polygonal shape with a diameter of about 1 to 15 μm. The diffusion beads 225 are dispersed in the first adhesive layer 220a at a ratio of about 1 to 5 wt %.

As shown in FIG. 6B, UV light is irradiated for several seconds to several tens of minutes. Accordingly, the first adhesive layer 220a is cured, so that the diffusion plate 210 and the first diffusion sheet 230a adhere to each other and are integrally formed.

As shown in FIG. 6C, a second diffusion sheet 230b having a plurality of holes 231b formed therein is arranged on the first diffusion sheet 230a to be in contact therewith. Here, the holes 231b formed in the second diffusion sheet 230b may be formed at the same positions as the holes 231a formed in the first diffusion sheet 230a, or at different positions therefrom. In addition, the holes 231b formed in the second diffusion sheet 230b are more concentrated in edge areas thereof. Also, an adhesive with diffusion beads 225 dispersed therein is dropped on the second diffusion sheet 230b. Thereafter, the surface of the second diffusion sheet 230b is scrubbed with a squeegee, roller, or the like, so that the adhesive spreads evenly. Accordingly, the adhesive penetrates downward through the holes 231b of the second diffusion sheet 230b, and thus, a second adhesive layer 220b is formed between the first diffusion sheet 230a and the second diffusion sheet 230b. At this time, the holes 231b of the second diffusion sheet 230b may be filled with the adhesive, or the adhesive may pass completely through the second diffusion sheet 230b so that the holes 231b are not filled with adhesive. As in the first adhesive layer 220a, the second adhesive layer 220b also includes a photo-crosslinking polymer solution composed of photopolymerization initiator, photopolymerizing monomer, or oligomer, has a UV adhesive curing mechanism as shown in FIG. 7A and FIG. 7B, and is mixed with an additional light stabilizer to be entirely cured during UV irradiation. Here, the number of the diffusion beads 225 dispersed in the second adhesive layer 220b is equal to or smaller than that in the first adhesive layer 220a.

As shown in FIG. 6D, UV light is irradiated for several seconds to several tens of minutes. Accordingly, the second adhesive layer 220b is cured, so that the first diffusion sheet 230a and the second diffusion sheet 230b adhere to each other and are integrally formed.

As shown in FIG. 6E, a third diffusion sheet 230c having a plurality of holes 231c formed therein is arranged on the second diffusion sheet 230b to be in contact therewith. Here, the holes 231c formed in the third diffusion sheet 230c may be formed at the same positions as the plurality of holes 231b formed in the second diffusion sheet 230b, or at different positions therefrom. Accordingly, the holes 231a, 231b, and 231c are formed at the same positions of the first, second, and third diffusion sheets 230a, 230b, and 230c, respectively, or at different positions thereof. Alternatively, the holes 231a and 231c are formed at the same positions of the first and third diffusion sheets 230a and 230c, respectively. In addition, the holes 231c formed in the third diffusion sheet 230c are more concentrated in edge areas thereof. Also, an adhesive with diffusion beads 225 dispersed therein is dropped on the third diffusion sheet 230c. Thereafter, the surface of the third diffusion sheet 230c is scrubbed with a squeegee, roller, or the like, so that the adhesive is spread evenly. Accordingly, the adhesive penetrates downward through the holes 231c of the third diffusion sheet 230c, and thus a third adhesive layer 220c is formed between the second diffusion sheet 230b and the third diffusion sheet 230c. At this time, the holes 231c of the third diffusion sheet 230c may be filled with the adhesive, or the adhesive may pass completely through the third diffusion sheet 230c so that the holes 231c are not filled with adhesive. Then, UV light is irradiated for several seconds to several tens of minutes so that the third adhesive layer 220c is cured, so that the second diffusion sheet 230b and the third diffusion sheet 230c adhere to each other and are integrally formed. Here, the number of the diffusion beads 225 dispersed in the third adhesive layer 220c is less than or equal to that in the second adhesive layer 220b. That is, the number of the diffusion beads 225 dispersed in the first, second, and third adhesive layers 220a, 220b, and 220c may be reduced in the upper layers as compared to the lower layers.

FIG. 7A and FIG. 7B are views for showing UV photopolymerization mechanism according to the present invention, particularly showing UV adhesive cure by means of UV irradiation. In FIG. 7A and FIG. 7B, ‘I’ designates a photopolymerization initiator, ‘M’ designates a photopolymerizing monomer, and ‘O-O’ designates a photopolymerizing oligomer.

As shown in FIG. 7A, the adhesive employed in this exemplary embodiment of the present invention has a photo-crosslinking polymer solution composed of photopolymerization initiator, photopolymerizing monomer, and oligomer. If such an adhesive is irradiated with UV light, the photopolymerization initiator, the photopolymerizing monomer, and oligomer are permanently coupled, thereby causing the upper and lower layers to adhere to each other and at the same time making it possible to selectively combine a refractive index and a light transmissivity.

The photopolymerization initiator used in this exemplary embodiment of the present invention may be selected from acetophenone, benzophenone, and thioxanthone, and the photopolymerizing monomer or oligomer is preferably selected from acrylate, epoxy acrylate, polyester acrylate, and urethane acrylate.

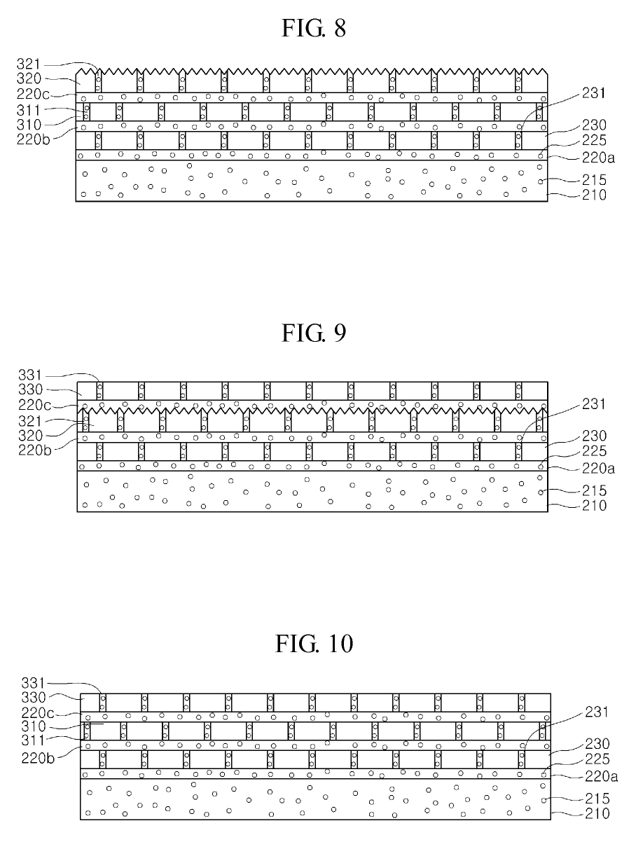

FIG. 8 is an enlarged sectional view of a light control member according to a third exemplary embodiment of the present invention. As shown in FIG. 8, a diffusion sheet 230 is integrally formed on a diffusion plate 210 with a first adhesive layer 220a, a micro-lens array 310 is integrally formed on the diffusion sheet 230 with a second adhesive layer 220b, and a prism sheet 320 is integrally formed on the micro-lens array 310 with a third adhesive layer 220c. Of course, diffusion beads 215 are dispersed in the diffusion plate 210, and diffusion beads 225 are also dispersed in the adhesive layers 220a, 220b, and 220c. In addition, a plurality of holes 231, 311, and 321 are formed, respectively, in the diffusion sheet 230, the micro-lens array 310, and the prism sheet 320 at different positions, so that the adhesive can penetrate downward through the holes.

FIG. 9 is an enlarged sectional view showing a light control member according to a fourth exemplary embodiment of the present invention. As shown in FIG. 9, a diffusion sheet 230 is integrally formed on a diffusion plate 210 with a first adhesive layer 220a, a prism sheet 320 is integrally formed on the diffusion sheet 230 with a second adhesive layer 220b, and a brightness-enhancing sheet 330 is integrally formed on the prism sheet 320 with a third adhesive layer 220c. Of course, diffusion beads 215 are dispersed in the diffusion plate 210, and diffusion beads 225 are also dispersed in the adhesive layers 220a, 220b, and 220c. In addition, a plurality of holes 231, 321, and 331 are formed in the diffusion sheet 230, the prism sheet 320, and the brightness-enhancing sheet 330 at different positions respectively, so the adhesive can penetrate downward through the holes.

FIG. 10 is an enlarged sectional view showing a light control member according to a fifth exemplary embodiment of the present invention. As shown in FIG. 10, a diffusion sheet 230 is integrally formed on a diffusion plate 210 with a first adhesive layer 220a, a micro-lens array 310 is integrally formed on the diffusion sheet 230 with a second adhesive layer 220b, and a brightness-enhancing sheet 330 is integrally formed on the micro-lens array 310 with a third adhesive layer 220c. Diffusion beads 215 are dispersed in the diffusion plate 210, and diffusion beads 225 are also dispersed in the adhesives 220a, 220b, and 220c. In addition, a plurality of holes 231, 311, and 331 are respectively formed in the diffusion sheet 230, the micro-lens array 310, and the brightness-enhancing sheet 330 respectively at different positions, so that the adhesive may penetrate downward through the holes.

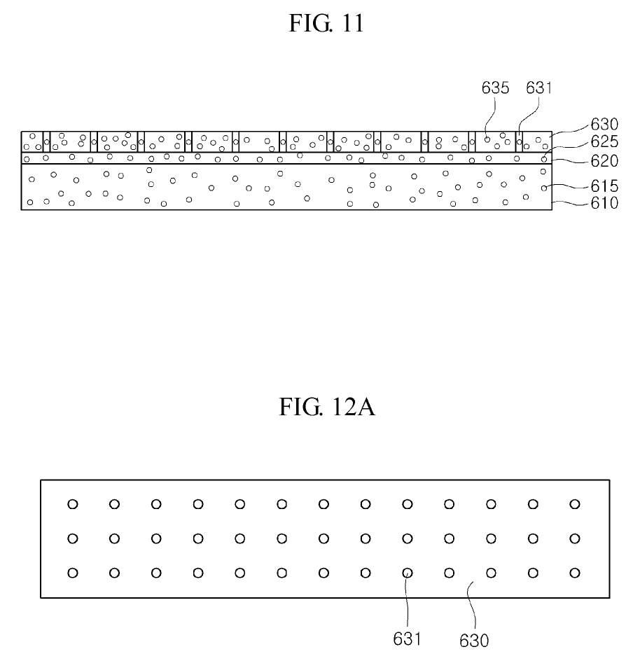

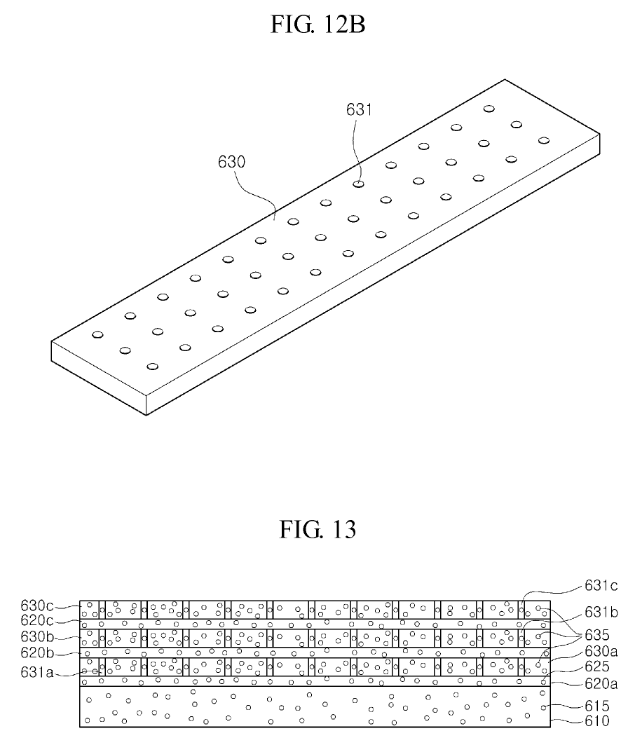

FIG. 11 is an enlarged sectional view of a light control member according to another exemplary embodiment of the present invention, and FIG. 12A and FIG. 12B are a plan view and a perspective view of a diffusion sheet used in the light control member according to another exemplary embodiment of the present invention.

The light control member 600 includes a diffusion plate 610, a diffusion sheet 630, and an adhesive layer 620 to integrally form the diffusion plate 610 and the diffusion sheet 630.

The diffusion plate 610 diffuses light supplied from a lamp unit positioned thereunder. The diffusion plate 610 is made of acrylic material or thermoplastic resin such as polymethylmethacrylate (PMMA). In addition, the diffusion plate 610 may have a plurality of diffusion beads 615 with a diameter of 1 to 15 μm dispersed therein as light diffusion particles.

The diffusion sheet 630 is integrally formed on the diffusion plate 610 with the adhesive layer 620 and scatters light provided through the diffusion plate 610 to diffuse the light. The diffusion sheet 630 has a plurality of holes 631 vertically perforating therethrough. The holes 631 each have a diameter of about 1 to 500 μm and may be arranged regularly or irregularly. Also, the diffusion sheet 630 has a plurality of diffusion beads 635, which act as light diffusion particles, having diameters of 10 to 20 μm dispersed therein, and the diffusion sheet 630 may be formed of polycarbonate (PC), polyethylene-based (PE-based) material such as PET (polyethyleneterephthalate), or the like.

The adhesive layer 620 causes the diffusion plate 610 and the diffusion sheet 630 to adhere to each other and to be integrally formed, and a plurality of diffusion beads 625, which act as light diffusion particles, are dispersed therein. The adhesive penetrates to the interface between the diffusion plate 610 and the diffusion sheet 630 through the holes 631 of the diffusion sheet 630 and then is cured through UV irradiation, which adheres the diffusion plate 610 and the diffusion sheet 630 to each other. Thus, the diffusion sheet 630 is disposed on the diffusion plate 610, the adhesive is dropped on the diffusion sheet 630, and then the surface of the diffusion sheet 630 is scrubbed with a squeegee, roller, or the like, so that the adhesive may penetrate downward through the holes 631. Here, the diffusion beads 625 dispersed in the adhesive layer 620 may be made of a material capable of diffusing light, such as acryl or silicon, and may be formed in a circular, oval, or polygonal shape with a diameter of about 1 to 15 μm. Also, the diffusion beads 625 are dispersed in the adhesive layer 620 at a ratio of about 1 to 5 wt %.

Meanwhile, the diffusion beads 615 in the diffusion plate 610, the diffusion beads 625 in the adhesive layer 620, and the diffusion beads 635 in the diffusion sheet 630 may have the same size or different sizes. Also, the diffusion sheet 630 on the diffusion plate 610 may have a multi-layered structure, in which individual layers are integrally formed with adhesive layers.

In addition, an optical sheet may be arranged on the diffusion sheet 630 formed integrally with the diffusion plate 610, and the optical sheet may be integrally formed on the diffusion sheet 630 with an adhesive layer. That is, it may be possible to adhere a micro-lens array, a prism sheet, and a brightness-enhancing sheet to the diffusion sheet 630 using additional adhesive layers. A plurality of holes is formed in each of the micro-lens array, the prism sheet, and the brightness-enhancing sheet, so that the adhesive can penetrate to a lower interface through the holes.

According to another exemplary embodiment of the present invention in which the diffusion plate 610 and the diffusion sheet 630 having the holes 631 are integrally formed with the adhesive layer 620 having diffusion beads 625 dispersed therein, it may be possible to integrally form a plurality of diffusion sheets 630 using adhesive layers 620. According to another exemplary embodiment, it is also possible to integrally form diffusion sheet 630 and various optical sheets 700 using adhesive layers 620. Hereinafter, the modifications of the exemplary embodiment of the present invention will be explained with reference to the accompanying drawings.

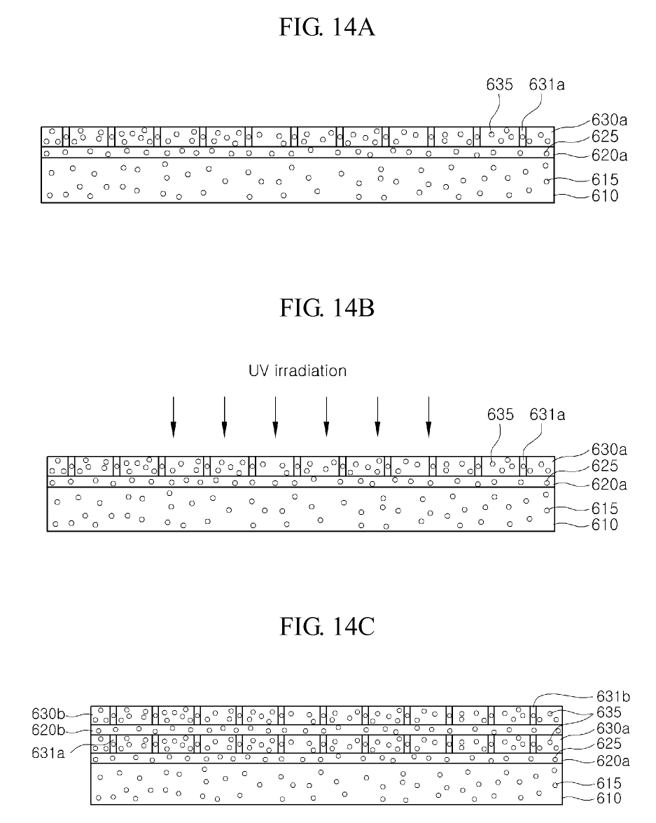

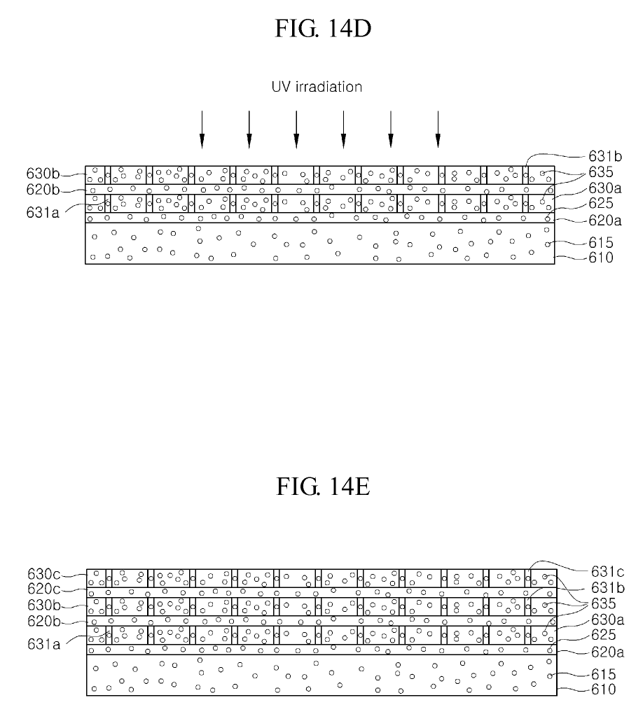

FIG. 13 is an enlarged sectional view of a light control member according to a seventh exemplary embodiment of the present invention, wherein three diffusion sheets, which each include a plurality of holes, are formed integrally with one diffusion plate with adhesive layers, and FIG. 14A, FIG. 14B, FIG. 14C, FIG. 14D, and FIG. 14E are sectional views subsequently showing a method for manufacturing the light control member according to the second exemplary embodiment of the present invention.

As shown in FIG. 14A, a first diffusion sheet 630a having a plurality of holes 631a formed therein is arranged on a diffusion plate 610 to be in contact therewith. Here, a plurality of diffusion beads 615 are dispersed in the diffusion plate 610, and a plurality of diffusion beads 635 are also dispersed in the first diffusion sheet 630a. In addition, the holes 631a formed in the first diffusion sheet 630a are more concentrated in edge areas thereof. In addition, an adhesive with diffusion beads 625 dispersed therein is dropped on the first diffusion sheet 630a. Thereafter, the surface of the first diffusion sheet 630a is scrubbed with a squeegee, roller, or the like, so that the adhesive spreads evenly. Accordingly, the adhesive penetrates downward through the holes 631a of the first diffusion sheet 630a, and a first adhesive layer 620a is formed between the diffusion plate 610 and the first diffusion sheet 630a. The first adhesive layer 620a includes a photo-crosslinking polymer solution composed of photopolymerization initiator, photopolymerizing monomer, or oligomer, and has a UV adhesive curing mechanism as shown in FIG. 7A and FIG. 7B. In addition, a light stabilizer is additionally mixed with the first adhesive layer 620a, so that the first adhesive layer 620a may be entirely cured during the following UV irradiation. Here, the weight ratio of photopolymerizing monomer to photopolymerization initiator is 900:1 to 4:1. In a case where the weight ratio is 4:1, since the content of the photopolymerization initiator is relatively high, the UV irradiation may be performed for several seconds. Meanwhile, in the case where the weight ratio is 900:1, since the content of the photopolymerization initiator is relatively low, UV irradiation may be performed for several tens of minutes. Of course, in order to shorten the curing time, it may be possible to increase the power of lamps emitting UV light, instead of increasing the content of photopolymerization initiator. The photopolymerization initiator may be selected from acetophenone, benzophenone, and thioxanthone. The photopolymerizing monomer or oligomer may be selected from acrylate, epoxy acrylate, polyester acrylate, and urethane acrylate. In addition, the diffusion beads 625 included in the first adhesive layer 620a may be made of a material capable of diffusing light, such as acryl or silicon, and may be formed in a circular, oval, or polygonal shape with a diameter of about 1 to 15 μm. The diffusion beads 625 are dispersed in the first adhesive layer 620a at a ratio of about 1 to 5 wt %.

As shown in FIG. 14B, UV light is irradiated for several seconds to several tens of minutes. Accordingly, the first adhesive layer 620a is cured, so that the diffusion plate 610 and the first diffusion sheet 630a adhere to each other and are integrally formed.

As shown in FIG. 14C, a second diffusion sheet 630b having a plurality of holes 631b formed therein is arranged on the first diffusion sheet 630a to be in contact therewith. At this time, the holes 631b formed in the second diffusion sheet 630b are more concentrated in edge areas thereof, and the holes 631a of the first diffusion sheet 630a and the holes 631b of the second diffusion sheet 630b are formed at the same positions. The second diffusion sheet 630b includes diffusion beads 625 dispersed therein. Also, an adhesive with diffusion beads 625 dispersed therein is dropped on the second diffusion sheet 630b. Thereafter, the surface of the second diffusion sheet 630b is scrubbed with a squeegee, roller, or the like, so that the adhesive spreads evenly. Accordingly, the adhesive penetrates downward through the holes 631b of the second diffusion sheet 630b, and thus a second adhesive layer 620b is formed between the first diffusion sheet 630a and the second diffusion sheet 630b. Similarly to the first adhesive layer 620a, the second adhesive layer 620b also includes a photo-crosslinking polymer solution composed of photopolymerization initiator, photopolymerizing monomer, or oligomer, has a UV adhesive curing mechanism as shown in FIG. 7A and FIG. 7B, and is mixed with an additional light stabilizer to be entirely cured during UV irradiation. Here, the number of the diffusion beads 625 dispersed in the second adhesive layer 620b is less than or equal to that in the first adhesive layer 620a.

As shown in FIG. 14D, UV light is irradiated for several seconds to several tens of minutes. Accordingly, the second adhesive layer 620b is cured, so that the first diffusion sheet 630a and the second diffusion sheet 630b adhere to each other and are integrally formed.

As shown in FIG. 14E, a third diffusion sheet 630c including a plurality of holes 631c and diffusion beads 635 dispersed therein is arranged on the second diffusion sheet 630b to be in contact with the second diffusion sheet 630b. At this time, the holes 631c formed in the third diffusion sheet 630c are more concentrated in edge areas thereof, and the holes 631b of the second diffusion sheet 630b and the holes 631c of the third diffusion sheet 630c are formed at the same positions. Accordingly, the holes 631a, 631b and 631c in the first, second, and third diffusion sheets 630a, 630b, and 630c are formed at the same position, respectively. Then, an adhesive with diffusion beads 625 dispersed therein is dropped on the third diffusion sheet 630c. Thereafter, the surface of the third diffusion sheet 630c is scrubbed with a squeegee, roller, or the like, so that the adhesive is spread evenly. Accordingly, the adhesive penetrates downward through the holes 631c of the third diffusion sheet 630c and thus a third adhesive layer 620c is formed between the second diffusion sheet 630b and the third diffusion sheet 630c. In addition, UV light is irradiated for several seconds to several tens of minutes, so that the third adhesive layer 620c is cured, and thus the second diffusion sheet 630b and the third diffusion sheet 630c adhere to each other and are integrally formed. Here, the number of the diffusion beads 625 dispersed in the third adhesive layer 620c is less than or equal to that of the diffusion beads 625 dispersed in the second adhesive layer 620b. That is, the number of the diffusion beads 625 dispersed in the first, second, and third adhesive layers 620a, 620b, and 620c may be reduced in the upper layers as compared to the lower layers.

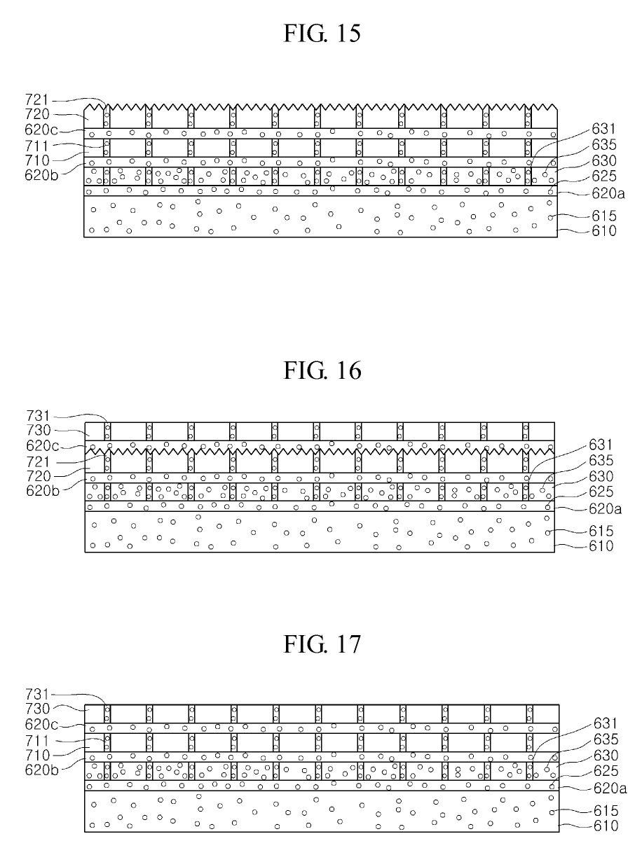

FIG. 15 is an enlarged sectional view of a light control member according to a third exemplary embodiment of the present invention. As shown in FIG. 15, a diffusion sheet 630 is integrally formed on a diffusion plate 610 with a first adhesive layer 620a, a micro-lens array 710 is integrally formed on the diffusion sheet 630 with a second adhesive layer 620b, and a prism sheet 720 is integrally formed on the micro-lens array 710 with a third adhesive layer 620c. Diffusion beads 615 are dispersed in the diffusion plate 610, diffusion beads 625 are also dispersed in the adhesives 620, and diffusion beads 635 are dispersed in the diffusion sheet 630. In addition, a plurality of holes 631, 711, and 712 are formed in the diffusion sheet 630, the micro-lens array 710, and the prism sheet 720 respectively, so that an adhesive may penetrate downward through the holes.

FIG. 16 is an enlarged sectional view showing a light control member according to a fourth exemplary embodiment of the present invention. As shown in FIG. 16, a diffusion sheet 630 is integrally formed on a diffusion plate 610 with a first adhesive layer 620a, a prism sheet 720 is integrally formed on the diffusion sheet 630 with a second adhesive layer 620b, and a brightness-enhancing sheet 730 is integrally formed on the prism sheet 720 with a third adhesive layer 620c. Diffusion beads 615 are dispersed in the diffusion plate 610, diffusion beads 625 are also dispersed in the adhesives 620, and diffusion beads 635 are dispersed in the diffusion sheet 630. In addition, a plurality of holes 631, 721, and 731 are formed in the diffusion sheet 630, the prism sheet 720, and the brightness-enhancing sheet 730 respectively, so that an adhesive may penetrate downward through the holes.

FIG. 17 is an enlarged sectional view showing a light control member according to a fifth exemplary embodiment of the present invention. As shown in FIG. 17, a diffusion sheet 630 is integrally formed on a diffusion plate 610 with a first adhesive layer 620a, a micro-lens array 710 is integrally formed on the diffusion sheet 630 with a second adhesive layer 620b, and a brightness-enhancing sheet 730 is integrally formed on the micro-lens array 710 with a third adhesive layer 620c. Of course, diffusion beads 615 are dispersed in the diffusion plate 610, diffusion beads 625 are dispersed in the adhesives 620, and diffusion beads 635 are dispersed in the diffusion sheet 630. In addition, a plurality of holes 631, 711, and 731 are formed in the diffusion sheet 630, the micro-lens array 710, and the brightness-enhancing sheet 730 respectively, so that an adhesive may penetrate downward through the holes.

So far, it has been described in an exemplary embodiment of the present invention that an optical sheet and a diffusion sheet having no diffusion bead dispersed therein are integrally formed by penetrating an adhesive through a plurality of holes formed at different positions. In addition, it has been described in another exemplary embodiment of the present invention that an optical sheet and a diffusion sheet having diffusion beads dispersed therein are integrally formed by penetrating an adhesive through a plurality of holes formed at the same positions. However, the present invention is not limited to the above exemplary embodiments, but it is also possible that at least one diffusion sheet or optical sheet having no hole is employed for the adhesion. That is, in a case where diffusion sheets and optical sheets adhere to each other in a multi-layered structure, it is possible that the sheets may adhere to each other while at least one sheet has a plurality of holes formed therein and rest of the sheets have no hole. At this time, the uppermost sheet may have no hole.

In addition, although it is shown in the above exemplary embodiments that a plurality of holes is formed to perforate vertically through the diffusion sheet or the optical sheet, the present invention is not limited thereto. That is, it is possible that the holes are formed not to perforate through an upper or lower layer of the diffusion sheet or the optical sheet. In such a case, it is preferred that an adhesive is applied to an upper portion of a lower layer, and then an upper layer is adhered thereto and is cured.

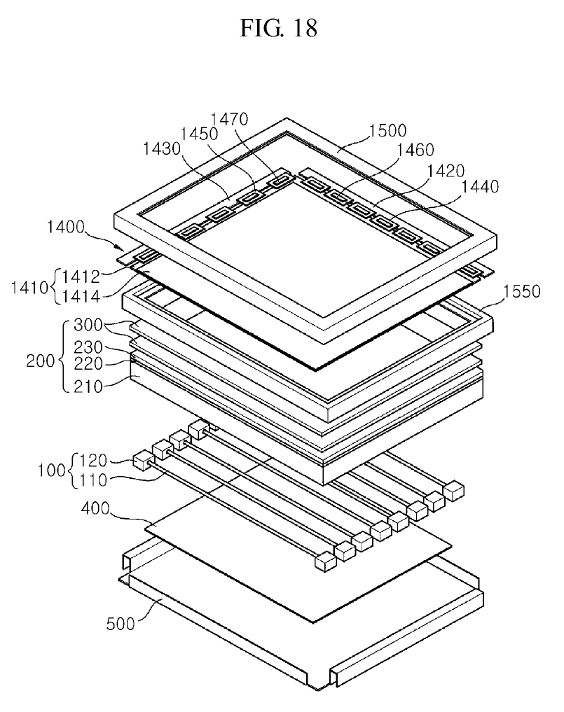

FIG. 18 is an exploded perspective view of an LCD according to an exemplary embodiment of the present invention.

Referring to FIG. 18, the LCD 1600 includes a backlight unit to supply light, a display unit 1400 to display an image using the light supplied from the backlight unit, and a top chassis 1500 to fix the display unit 1400 to the backlight unit.

The backlight unit includes a lamp unit 100 to generate light, a diffusion plate 210 formed over the lamp unit 100 to diffuse the light generated from the lamp unit 100, and a diffusion sheet 230 formed integrally with the diffusion plate 210 to diffuse the light provided from the diffusion plate 210. In addition, the backlight unit includes optical sheets 300 disposed over or formed integrally with the diffusion sheet 230 to enhance optical characteristics of the light provided from the diffusion sheet 230, a reflective plate 400 formed under the lamp unit 100 to reflect light leaking from the lamp unit 100 toward the display unit 1400, and a receiving container 500 formed under the reflective plate 400 to contain the lamp unit 100, the diffusion plate 210, the diffusion sheet 230, and the optical sheets 300.

Meanwhile, the display unit 1400 includes an LCD panel 1410 to display an image, and a source printed circuit board (PCB) 1420 and a gate PCB 1430 to provide driving signals to drive the LCD panel 1410.

The driving signals provided from the source and gate PCBs 1420 and 1430 are applied to the LCD panel 1410 through data and gate flexible circuit films 1440 and 1450. The data and gate flexible circuit films 1440 and 1450 may include a tape carrier package (TCP) or a chip on film (COF). Here, the data and gate flexible circuit films 1440 and 1450 further include data and gate driving chips 1460 and 1470 to control the timing of the driving signals so that the driving signals provided from the source and gate PCBs 1420 and 1430 are each applied to the LCD panel at the right timing.

The LCD panel 1410 includes a thin film transistor (TFT) substrate 1412, a color filter substrate 1414 bonded to the TFT substrate 1412 to face each other, and liquid crystals (not shown) interposed between the two substrates 1412 and 1414.

The TFT substrate 1412 is a transparent glass substrate in which TFTs (not shown) acting as switching elements are arranged in a matrix form. A data line is connected to a source terminal of each TFT, and a gate line is connected to a gate terminal. In addition, a pixel electrode made of a transparent conductive material is connected to a drain terminal.

The color filter substrate 1414 is arranged to face the TFT substrate 1412, which is spaced apart from the color filter substrate by a predetermined interval. The color filter substrate 1414 is a substrate in which RGB pixels, acting as color pixels showing predetermined colors when light passes therethrough, are formed through a thin film process. A common electrode made of a transparent conductive material is formed on an entire surface of the color filter substrate 1414.

The LCD panel 1410 configured as above forms an electric field between the pixel electrode and the common electrode if power is applied to the gate terminal of the TFT, thereby turning on the TFT. This electric field changes the arrangement of the liquid crystals interposed between the TFT substrate 1412 and the color filter substrate 1414, and the arrangement change of the liquid crystals changes the transmissivity of the light supplied from the backlight unit, whereby an image of desired gradation may be obtained. The source PCB 1420 is connected to one end of the TFT substrate 1412 through the data flexible circuit film 1440.

In addition, the gate PCB 1430 is connected to the other end of the TFT substrate 1412 through the gate flexible circuit film 1450. Thus, the source and gate PCBs 1420 and 1430 generate and output data and gate driving signals for driving the LCD panel 1410.

The data driving signal is applied to the data line formed in the TFT substrate 1412 through the data flexible circuit film 1440. The gate diving signal is applied the gate line formed in the TFT substrate 1412 via the gate flexible circuit film 1450. To this end, a conductive wire (not shown) may be formed on the TFT substrate 1412 to connect the data flexible circuit film 1440 and the gate flexible circuit film 1450.

The display unit 1400 is mounted from an upper position of the backlight unit. At this time, the LCD panel 1410 is accommodated in a mold frame 1550 and then arranged over the backlight unit. In addition, the source PCB 1420 is fixed to a rear surface of the receiving container 400 by bending the data flexible circuit film 1440.

The top chassis 1500 is coupled to the receiving container 500 while surrounding edges of the LCD panel 1410 received in the backlight unit. The top chassis 1500 prevents the LCD panel 1410 from being broken due to an external impact, and also from being separated from the receiving container 500.

Although the above explanation has been based on a direct-type backlight unit using a diffusion plate, the prevent invention may also be applied to an edge-type backlight unit using a light guide plate. In addition, although the present invention has been explained based on an LCD, the present invention may also be applied to any other kinds of displays having a diffusion plate or a light guide plate for diffusing light.

According to the present invention so configured, a diffusion plate is formed integrally with a diffusion sheet or an optical sheet using an adhesive with diffusion beads dispersed therein, which may provide for easy handling of a backlight unit while also decreasing costs by reducing the processes and materials required. In addition, it may be possible to reduce the loss of intensity of light by eliminating an air layer between a diffusion plate and a diffusion sheet or an optical sheet. It also may be possible to enhance brightness since an adhesive with diffusion beads dispersed therein is used to decrease the refractive index difference between the diffusion plate and the diffusion or optical sheet. Meanwhile, it may also be possible to decrease the overall thickness of the display by integrally forming the diffusion plate and the diffusion or optical sheet.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A backlight unit, comprising:
an optical plate;
an adhesive layer disposed on the optical plate, the adhesive layer having diffusion beads dispersed therein; and
a light control sheet adhering to and formed integrally with the optical plate through the adhesive layer, the light control sheet having a plurality of holes formed therein.

2. The backlight unit of claim 1, wherein the optical plate comprises a diffusion plate.

3. The backlight unit of claim 1, wherein the light control sheet comprises a diffusion sheet.

4. The backlight unit of claim 1, wherein the light control sheet comprises one or more layers integrally formed with adhesive layers.

5. The backlight unit of claim 3, wherein the optical sheet comprises at least one of a micro-lens array, a prism sheet, and a brightness-enhancing sheet.

6. The backlight unit of claim 2, wherein the diffusion plate has a plurality of diffusion beads dispersed therein.

7. The backlight unit of claim 3, wherein the diffusion sheet has a plurality of diffusion beads dispersed therein.

8. The backlight unit of claim 4, wherein the multi-layered light control sheet has the plurality of holes formed in one or more of the sheet layers.

9. The backlight unit of claim 8, wherein the plurality of holes are formed at the same positions in the respective sheet layers of the multi-layered light control sheet.

10. The backlight unit of claim 8, wherein the plurality of holes are formed at different positions of the respective sheet layers of the multi-layered light control sheet.

11. The backlight unit of claim 1, wherein the diffusion beads comprise at least one of acryl and silicon.

12. The backlight unit of claim 1, wherein the diffusion beads are dispersed in the adhesive layer at a ratio of 1 to 5 wt %.

13. The backlight unit of claim 1, wherein the adhesive layer fills the holes of the light control sheet.

14. The backlight unit of claim 4, wherein the number of diffusion beads in the adhesive layers is reduced in upper layers as compared to lower layers.

15. The backlight unit of claim 1, wherein the adhesive layer comprises a photo-crosslinking polymer solution comprising photopolymerization initiator, photopolymerizing material.

16. A method for manufacturing a backlight unit, comprising:
forming a light control sheet on an optical plate, the light control sheet having a plurality of holes formed therein;
disposing an adhesive with diffusion beads dispersed therein between the optical plate and the light control sheet through the holes; and
curing the adhesive through UV irradiation to integrally form the optical plate and the light control sheet.

17. The method of claim 16, wherein the light control sheet having the holes formed therein includes a plurality of sheets integrally formed with adhesive layers.

18. A display, comprising:
a light source to provide light;
a backlight unit comprising a light control member to control the light provided from the light source, the light control member comprising an optical plate integrally formed with a light control sheet using an adhesive layer comprising diffusion beads dispersed therein, the light control sheet having a plurality of holes formed therein; and
a panel to display an image using light supplied from the backlight unit.

19. The display of claim 18, wherein the light source emits light to a side or lower surface of the optical plate.
